(19) United States
(12) Patent Application Publication
(10) Pub. No.: US 2026/0298354 A1
(43) Pub. Date: Oct. 1, 2026

(54) RECIRCULATION VALVE

(71) Applicant: KYUNGDONG NAVIEN CO., LTD., Gyeonggi-do (KR)

(72) Inventor: Hee Su AHN, Seoul (KR)

(73) Assignee: KYUNGDONG NAVIEN CO., LTD., Gyeonggi-do (KR)

(21) Appl. No.: 18/877,361

(22) PCT Filed: Jun. 1, 2023
(86) PCT No.: PCT/KR2023/007547

§ 371 Date: Dec. 20, 2024

(30) Foreign Application Priority Data
Aug. 26, 2022 (KR) 10-2022-0107238

(51) Int. Cl. F16K 7/12; E03C 1/04; F16K 21/04; G05D 7/01

(52) U.S. Cl. CPC F16K 7/12; E03C 1/04; F16K 21/04; G05D 7/012; F16K 2200/201; F16K 2200/204

(57) ABSTRACT

A recirculation valve according to the present invention comprises: a hot water housing forming a hot water channel provided to allow hot water to flow therethrough; a direct water housing forming a direct water channel provided to allow direct water to flow therethrough; a recirculation housing forming a recirculation channel allowing hot water in the hot water channel to flow into the direct water channel; a hydraulic opening and closing body provided to close or open the recirculation channel; and a bimetal plate configured to be deformed according to the temperature of the hot water to open or close an inlet channel, which is part of the recirculation channel, wherein the recirculation housing includes an inlet case located upstream of the bimetal plate, and the inlet case includes a case body in which the inlet channel is formed, and a case locking protrusion configured to surround the inlet channel from the case body.

### CROSS-REFERENCE TO RELATED APPLICATIONS

This application claims priority under 35 U.S.C. § 119 to Korean Patent Application No. 10-2022-0107238 filed on Aug. 26, 2022, in the Korean Intellectual Property Office, the disclosures of which are incorporated by reference herein in their entireties.

### TECHNICAL FIELD

The present disclosure relates to a recirculation valve for hot water.

### BACKGROUND ART

A hot water recirculation system may be implemented to always supply hot water at a temperature higher than or equal to a specific temperature. In the hot water recirculation system, even when the use of the hot water is stopped so that the hot water is not discharged, the hot water discharged from a boiler may return to the boiler through a direct water pipe and may be reheated in the boiler. To repeat this process, the hot water may be maintained at a predetermined temperature while the hot water circulates.

However, since the direct water pipe is used to recirculate the hot water, the introduction of the hot water into the direct water pipe has to be prevented when direct water is used at a consumption site. In addition, even when the hot water is used at the consumption site, the hot water has to be supplied to the consumption site and then discharged without being circulated.

Accordingly, a recirculation valve is required in the hot water recirculation system to block the circulation of the hot water when the direct water or the hot water is used and to circulate the hot water when the direct water or the hot water is not used.

FIG. 1 is a longitudinal sectional view of a conventional recirculation valve. As can be seen in the drawing, in the conventional recirculation valve using bimetal, hot water flows to the right through a recirculation housing RH connecting a passage of direct water or hot water flowing in one direction (the upper direction in the drawing) to another direction (the left-right direction in the drawing) perpendicular to the one direction and then flows into a direct water passage to circulate. However, when the hot water is recirculated, the hot water flowing upward flows while being diverted to the right, and therefore the flow velocity of the hot water at each location within the recirculation housing RH varies in the up-down direction due to the inertia. Since the hot water flowing upward is diverted, a larger amount of hot water flows at the upper side within the recirculation housing RH than at the lower side within the recirculation housing RH, and a pressure gradient is generated on a bimetal plate BP disposed in the recirculation housing RH. As the pressure gradient is generated on the bimetal plate BP, abnormal operation or excessive noise may be generated when the bimetal plate BP operates. The abnormal operation or noise may be intensified when the hot water flowing in the recirculation housing RH forms a turbulent flow.

### DISCLOSURE

### Technical Problem

The present disclosure has been made to solve the aforementioned problems occurring in the related art. An aspect of the present disclosure provides a recirculation valve having a structure of a recirculation housing for reducing abnormal operation or noise during operation of a bimetal plate by reducing pressure imbalance applied to the bimetal plate.

### Technical Solution

A recirculation valve according to an embodiment of the present disclosure includes a hot water housing that is fluidically connected to a hot water supply pipe that supplies hot water generated by heating raw water and that forms a hot water passage through which the hot water flows in a first reference direction, a direct water housing that is fluidically connected to a direct water supply pipe that supplies direct water being raw water and that forms a direct water passage through which the direct water flows, a recirculation housing that forms a recirculation passage in a second reference direction perpendicular to the first reference direction to fluidically connect the hot water passage and the direct water passage and cause the hot water in the hot water passage to flow into the direct water passage, a water-pressure opening/closing body provided in the direct water housing to close or open the recirculation passage, and a bimetal plate disposed in the recirculation housing and deformed depending on a water temperature of the hot water to open or close an inlet passage being a portion of the recirculation passage. The recirculation housing includes an inlet case located upstream of the bimetal plate based on the second reference direction, and the inlet case includes a case body having the inlet passage formed therein and a case locking jaw that protrudes from the case body in a direction opposite to the second reference direction and surrounds the inlet passage.

### Advantageous Effects

Accordingly, the pressure imbalance applied to the bimetal plate may be reduced, and thus abnormal operation or noise during operation of the bimetal plate may be reduced.

### DESCRIPTION OF DRAWINGS

FIG. 1 is a longitudinal sectional view of a conventional recirculation valve.

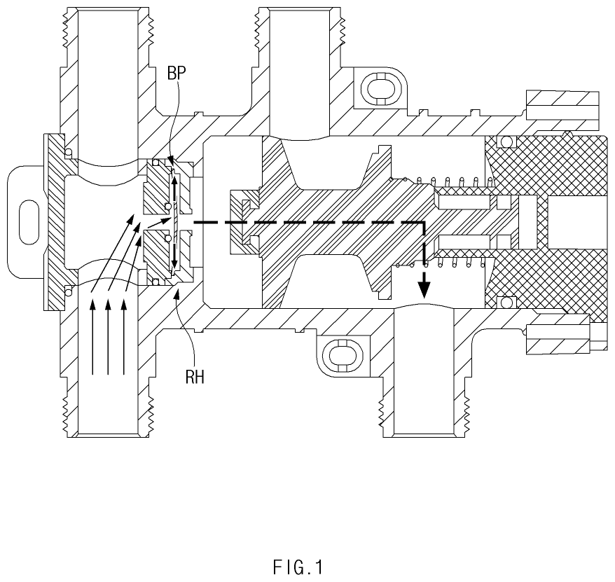

FIG. 2 is a schematic view of a hot water recirculation system using a recirculation valve according to an embodiment of the present disclosure.

FIG. 3 is an exploded perspective view of the recirculation valve according to an embodiment of the present disclosure.

FIG. 4 is a longitudinal sectional view of the recirculation valve according to an embodiment of the present disclosure.

FIG. 5 is a view illustrating a recirculation housing and a cover of the recirculation valve according to an embodiment of the present disclosure.

FIG. 6 is a perspective view of a recirculation housing according to another embodiment of the present disclosure.

FIG. 7 is a longitudinal sectional view of the recirculation housing of a recirculation valve according to the other embodiment of the present disclosure.

### MODE FOR INVENTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. When a component is described as “connected”, “coupled”, or “linked” to another component, this may mean the components are not only directly “connected”, “coupled”, or “linked” but also are indirectly “connected”, “coupled”, or “linked” via a third component.

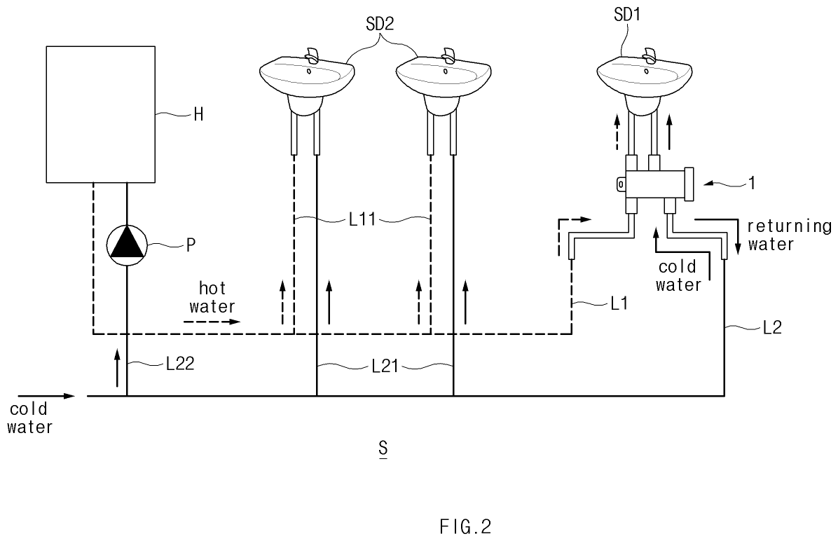

FIG. 2 is a schematic view of a hot water recirculation system S using a recirculation valve 1 according to an embodiment of the present disclosure.

Referring to FIG. 2, the hot water recirculation system S using the recirculation valve 1 according to an embodiment of the present disclosure includes a heat source H, the recirculation valve 1, a hot water supply pipe L1, a direct water supply pipe L2, and a recirculation pipe L22.

The heat source H is a component that heats direct water or returning water, which is introduced raw water, and generates hot water. Accordingly, a boiler including a heat exchanger that heats the direct water using at least one of sensible heat or latent heat of a combustion gas through combustion of a fuel may be disposed as the heat source H. However, another device instead of the boiler may be disposed and used as the heat source H, as long as the device is capable of receiving and heating the direct water or the returning water, generating the hot water, and sending out the hot water.

When the temperature of introduced water is below a predetermined temperature or the flow rate of the introduced water is greater than or equal to an operating flow rate, the heat source H may operate to heat the introduced water, generate hot water, and send out the hot water. Accordingly, the operation of the heat source H may be controlled by adjusting the flow rate. For this operation, a flow sensor (not illustrated) that is capable of measuring the flow rate may be disposed in the heat source H, and a controller (not illustrated) that is constituted by a microprocessor capable of operating the heat source H depending on an electrical signal generated by the flow sensor may be further provided.

The recirculation pipe L22 may be connected to the heat source H so that the direct water or returning water that is raw water delivered from the direct water supply pipe L2 may be introduced into the heat source H. The direct water or returning water may be used as raw water, and the raw water may be heated by the heat source H and discharged as hot water. The hot water supply pipe L1 is connected to the heat source H, and the hot water is discharged through the hot water supply pipe L1.

The hot water supply pipe L1 is a component that is connected with the heat source H and that supplies the hot water to a consumption site SD1. One end is connected to the heat source H, and an opposite end passes through the recirculation valve 1 and is connected to the consumption site SD1. Accordingly, the hot water supply pipe L1 serves to deliver the hot water from the heat source H to the consumption site SD1. The hot water supply pipe L1 may come out from the heat source H and may be connected to the consumption site SD1 through the recirculation valve 1 or may be directly connected to other consumption sites SD2 through other hot water supply pipes L11 diverging from the hot water supply pipe L1 to supply the hot water to the consumption site SD1 and the other consumption sites SD2.

The consumption site SD1 and the other consumption sites SD2 may be water faucets capable of discharging the hot water and the direct water to the outside and adjusting the degree of discharge as illustrated, but are not limited thereto.

The direct water supply pipe L2 is a component that is connected with a direct water source and that supplies the direct water to the consumption site SD1. The direct water supply pipe L2 may be connected at one end thereof to the external direct water source that is a water supply source that supplies the direct water and may receive the direct water and cause the direct water to flow, or may be directly connected to the other consumption sites SD2 through other direct water supply pipes L21 diverging from the direct water supply pipe L2 and may supply the direct water. As illustrated, the direct water supply pipe L2 may pass through the recirculation valve 1 before being connected to the consumption site SD1.

The recirculation pipe L22 is a component that is connected with the direct water supply pipe L2 and that causes the direct water to flow from the direct water source to the heat source H or causes the returning water, which is delivered to the direct water supply pipe L2 through a recirculation passage formed in a housing of the recirculation valve 1 that will be described below, to flow into the heat source H. Accordingly, the recirculation pipe L22 may directly or indirectly connect the direct water source and the heat source H and may cause the direct water to be delivered to the heat source H. In addition, the recirculation pipe L22 may cause the returning water generated from the recirculation passage to be delivered to the heat source H through the direct water supply pipe L2. That is, the recirculation pipe L22 is a component that delivers water to the heat source H.

As illustrated, based on the direction in which the direct water flows in the direct water supply pipe L2, one end of the recirculation pipe L22 is connected to one point of the direct water supply pipe L2 located upstream of the point where the direct water supply pipe L2 bifurcates, and an opposite end of the recirculation pipe L22 is connected to the heat source H. Accordingly, the returning water that flows in the direction opposite to the flow direction of the direct water and returns to the one point and the direct water that flows downstream from the direct water source and that is delivered to the one point may be delivered to the heat source H through the recirculation pipe L22.

To cause the recirculation pipe L22 to deliver the direct water or the returning water to the heat source H as described above, a pump P may be provided for the recirculation pipe L22. The pump P pressurizes the direct water or the returning water flowing in the recirculation pipe L22 and forces the direct water or the returning water into the heat source H. Accordingly, the pump P provides power to circulate the hot water in the entire hot water recirculation system S.

The recirculation valve 1 is a component that determines whether to recirculate the hot water in the hot water recirculation system S according to an embodiment of the present disclosure. The recirculation valve 1 is connected to the hot water supply pipe L1 and the direct water supply pipe L2 and includes the recirculation passage that delivers the hot water delivered from the hot water supply pipe L1 to the direct water supply pipe L2 to generate the returning water. Accordingly, the hot water recirculation system S operates as follows.

The direct water is provided from the direct water source to the direct water supply pipe L2. A portion of the direct water is provided to the other consumption sites SD2 through the other direct water supply pipes L21 or delivered to the consumption site SD1 through the direct water supply pipe L2 and the recirculation valve 1. Another portion of the direct water is delivered to the heat source H through the recirculation pipe L22.

The heat source H heats the direct water to generate hot water and sends out the hot water. A portion of the hot water is provided to the other consumption sites SD2 through the other hot water supply pipes L11 or delivered to the consumption site SD1 through the hot water supply pipe L1 and the recirculation valve 1. Another portion of the hot water may be provided to the direct water supply pipe L2 through the recirculation passage of the recirculation valve 1 and may return in the direction opposite to the flow direction of the direct water along the direct water supply pipe L2.

The water returning in the reverse direction along the direct water supply pipe L2 flows into the heat source H through the recirculation pipe L22. The heat source H heats the returning water again to generate hot water and sends out the hot water through the hot water supply pipe L1.

The recirculation valve 1 adjusts the flow rate of the recirculated hot water while the recirculation process is performed.

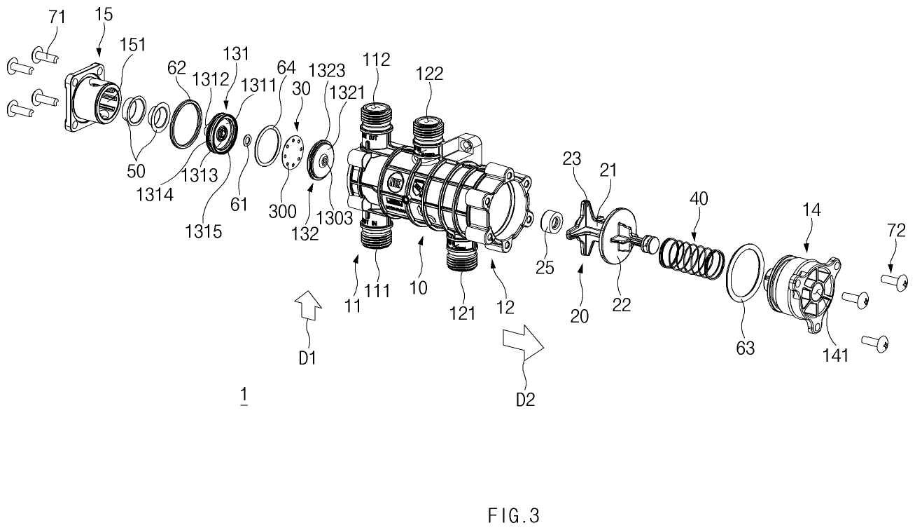

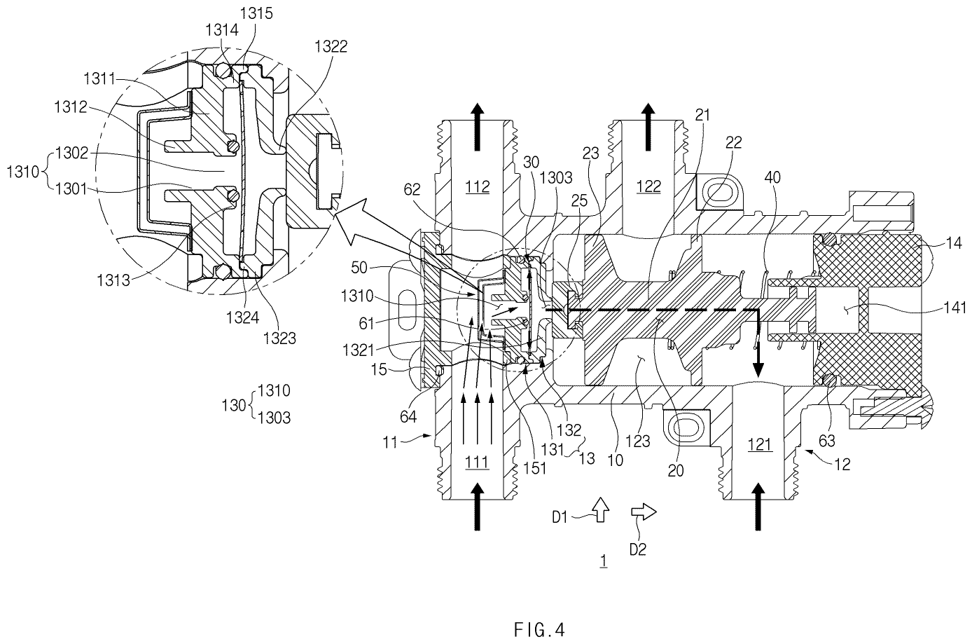

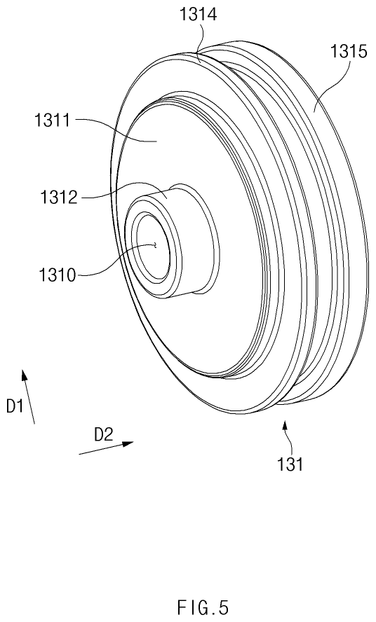

FIG. 3 is an exploded perspective view of the recirculation valve 1 according to an embodiment of the present disclosure. FIG. 4 is a longitudinal sectional view of the recirculation valve 1 according to an embodiment of the present disclosure. FIG. 5 is a view illustrating an inlet case and a cover of the recirculation valve 1 according to an embodiment of the present disclosure.

Referring to FIGS. 3 to 5, the recirculation valve 1 according to an embodiment of the present disclosure includes a housing 10, a water-pressure opening/closing body 20, and a bimetal plate 30.

### Housing 10

The housing 10 is a component that forms the exterior of the recirculation valve 1. The housing 10 includes a housing body having an empty space inside and a front cover 15 and a back cover 14 that cover some of the openings formed in the housing body. In addition, the open interior of the housing 10 includes a hot water passage 110, a direct water passage 120, and a recirculation passage 130. The housing includes a hot water housing 11, a direct water housing 12, and a recirculation housing 13. The hot water housing 11, the direct water housing 12, and the recirculation housing 13 may be assembled together to form one housing 10, and as illustrated, the housing body may have a form in which the hot water housing 11 and the direct water housing 12 are integrally formed with each other and the recirculation housing 13 is coupled therein.

The hot water housing 11 is a housing that is fluidically connected to the hot water supply pipe L1 for supplying hot water generated by heating raw water and that forms the hot water passage 110. The hot water passage 110 is a passage connecting two openings among the openings of the housing 10. The hot water passage 110 is fluidically connected to the hot water supply pipe L1 for supplying the hot water generated by heating the raw water to the consumption site SD1, and the hot water flows through the hot water passage 110. Accordingly, the hot water passage 110 includes a hot water supply passage 111 that is fluidically connected with a portion of the hot water supply pipe L1 and that receives the hot water and a hot water discharge passage 112 that discharges the hot water from inside the housing 10 and supplies the hot water to the consumption site SD1 through another portion of the hot water supply pipe L1. The hot water supply passage 111 and the hot water discharge passage 112 are connected to different openings.

As illustrated, the hot water supply passage 111 and the hot water discharge passage 112 may be disposed to extend along the same straight line. The hot water passage 110 may be formed in a first reference direction D1. The hot water discharge passage 112 may be located in the first reference direction D1 with respect to the hot water supply passage 111, and the hot water may flow in the hot water passage 110 in the first reference direction D1.

The front cover 15 may be disposed between the hot water supply passage 111 and the hot water discharge passage 112. The inside of the front cover 15 may be open to fluidically connect the hot water supply passage 111 and the hot water discharge passage 112. Accordingly, the front cover 15 may form a portion of the hot water passage 110. The front cover 15 may be detachably coupled to the housing 10 and may facilitate assembling and replacing the bimetal plate 30, the inlet case 131, and an outlet case 132 that will be described below. A front cover O-ring 64 that maintains water tightness between the front cover 15 and the housing 10 to prevent the hot water from being leaked from the front cover 15 may be placed at the boundary between the front cover 15 and the housing body. The front cover O-ring 64 may be formed of a material having elasticity.

The front cover 15 may be fastened to the housing body using a front fastener 71. The front fastener 71 may be a bolt and may be provided in plural. The front fastener 71 may be coupled to a fastening hole formed in the housing body and a fastening hole formed in the front cover 15 to couple the front cover 15 and the front fastener 71.

The recirculation passage 130 is fluidically connected with the hot water passage 110 in the area where the front cover 15 is disposed. Accordingly, a portion of the hot water provided through the hot water supply passage 111 may be delivered to the hot water discharge passage 112, and in the area where the front cover 15 is disposed, the remaining portion may flow into the recirculation passage 130 to enter a recirculation process.

The direct water housing 12 is a housing fluidically connected to the direct water supply pipe L2 for supplying direct water, which is raw water, to form the direct water passage 120. The direct water passage 120 is a passage that is fluidically connected to the direct water supply pipe L2 for supplying the direct water, which is raw water, to the consumption site SD1 and through which the direct water flows. The direct water passage 120 includes a direct water supply passage 121 that supplies the direct water into the housing 10 and discharges the hot water to the outside of the housing 10 for recirculation of the hot water introduced along the recirculation passage 130 that will be described below and a direct water discharge passage 122 that discharges the direct water to the outside of the housing 10. In addition, the direct water passage 120 includes an intermediate direct water passage 123 that is fluidically connected with the recirculation passage 130 and that connects the direct water supply passage 121 and the direct water discharge passage 122 and accommodates the water-pressure opening/closing body 20 that will be described below. Accordingly, the direct water is delivered from the direct water supply passage 121 to the direct water discharge passage 122 through the intermediate direct water passage 123 and delivered to the consumption site SD1.

The direct water supply passage 121 and the direct water discharge passage 122 are spaced apart from each other in the extension direction of the intermediate direct water passage 123 and fluidically connected to the intermediate direct water passage 123. Accordingly, the direct water supply passage 121 and the direct water discharge passage 122 are staggered with respect to each other, and the direct water flowing in the direct water supply passage 121 is not directly delivered to the direct water discharge passage 122 without passing through the intermediate direct water passage 123 or without being obstructed by the water-pressure opening/closing body 20 accommodated in the intermediate direct water passage 123. The direct water flowing in the direct water supply passage 121 is delivered to the direct water discharge passage 122 through the intermediate direct water passage 123.

As illustrated, the extension directions of the direct water supply passage 121 and the direct water discharge passage 122 may not be on one straight line. As illustrated, the direct water supply passage 121 and the direct water discharge passage 122 may be formed in the first reference direction D1. The intermediate direct water passage 123 may be formed in a second reference direction D2 perpendicular to the first reference direction D1. The direct water discharge passage 122 may be located in the first reference direction D1 with respect to the direct water supply passage 121, and the direct water may flow in the direct water passage 120 in the order of the first reference direction D1, the second reference direction D2, and the first reference direction D1.

One end of the intermediate direct water passage 123 may be fluidically connected with the recirculation passage 130, and an opposite end of the intermediate direct water passage 123 may be closed by the back cover 14. Accordingly, the hot water is delivered from the hot water passage 110 to the intermediate direct water passage 123 through the recirculation passage 130, and the hot water delivered in this way naturally flows into the direct water supply passage 121, flows in the direction opposite to the direction in which the direct water flows, and becomes returning water.

The back cover 14 may be fastened to the housing body using a rear fastener 72. The rear fastener 72 may be a bolt and may be provided in plural. The rear fastener 72 may be coupled to a fastening hole formed in the housing body and a fastening hole formed in the back cover 14 to couple the back cover 14 and the rear fastener 72.

To maintain water tightness of the intermediate direct water passage 123, a back cover O-ring 63 may be disposed at the boundary between the inner surface of the housing body that forms the intermediate direct water passage 123 and the back cover 14. The back cover O-ring 63 may be formed of a material having elasticity.

The recirculation passage 130 is a passage that fluidically connects the hot water passage 110 and the direct water passage 120 and causes the hot water in the hot water passage 110 to flow into the direct water passage 120. The recirculation passage 130 may be formed by the recirculation housing 13. The recirculation passage 130 may be formed by opening the recirculation housing 13 in the second reference direction D2.

### Water-Pressure Opening/Closing Body 20

The water-pressure opening/closing body 20 is a component configured to close or open the recirculation passage 130. The water-pressure opening/closing body 20 may be accommodated in the intermediate direct water passage 123 and may move in the extension direction of the intermediate direct water passage 123. When the direct water or the hot water is used, the water-pressure opening/closing body 20 moves to close the recirculation passage 130, and when the direct water and the hot water are not used, the water-pressure opening/closing body 20 moves in the direction opposite to the direction in which the water-pressure opening/closing body 20 moves when the direct water or the hot water is used and opens the recirculation passage 130. The direction in which the water-pressure opening/closing body 20 moves when the direct water or the hot water is used may be the direction opposite to the second reference direction D2 in which the hot water flows along the recirculation passage 130, and the direction in which the water-pressure opening/closing body 20 moves when the direct water and the hot water are not used may be the same as the second reference direction D2.

The direct water pressure of the direct water source that supplies the direct water is higher than the internal pressure of the hot water passage 110. Accordingly, even though only the direct water is used so that the internal pressure of the direct water passage 120 is slightly lowered, the internal pressure of the direct water passage 120 is higher than the internal pressure of the hot water passage 110, and therefore the water-pressure opening/closing body 20 is pressed by the direct water in the direction opposite to the second reference direction D2 and maintained in a state of closing the recirculation passage 130. Even when only the hot water is used, the internal pressure of the direct water passage 120 from which the direct water is not discharged is pressurized by the pump P, but the internal pressure of the direct water passage 120 is higher than the internal pressure of the hot water passage 110 that is slightly lowered as the hot water is discharged. Accordingly, the water-pressure opening/closing body 20 is pressed by the direct water in the direction opposite to the second reference direction D2 and maintained in the state of closing the recirculation passage 130. For the same reason, the recirculation passage 130 is closed by the water-pressure opening/closing body 20 even though the direct water and the hot water are used together.

As described above, the recirculation passage 130 is closed when the hot water or the direct water is used, and thus a situation in which the direct water and the hot water are mixed with each other and supplied to the consumption site SD1 at an undesired water temperature is prevented.

The water-pressure opening/closing body 20 may include a shaft 21, a flange 22, and an arm 23. The shaft 21 is a component that forms the skeleton of the water-pressure opening/closing body 20. The shaft 21 extends in the extension direction of the intermediate direct water passage 123 and is supported by the back cover 14 that forms the inner surface of the housing 10 that defines the intermediate direct water passage 123. To open or close the recirculation passage 130, one end of the shaft 21 is disposed adjacent to an opening of an outlet passage 1303 of the recirculation passage 130 that faces in the second reference direction D2. An opposite end of the shaft 21 is inserted into a sliding hole 141 of the back cover 14. Accordingly, the shaft 21 may perform a linear motion in the extension direction of the intermediate direct water passage 123 while sliding in a state of being guided by the sliding hole 141.

The flange 22 is a part extending from the shaft 21 in the radial direction and is pressed by the direct water or the hot water to enable the water-pressure opening/closing body 20 to linearly move in the extension direction of the intermediate direct water passage 123. The outer surface of the flange 22 may be formed to correspond to the shape of the inner surface of the intermediate direct water passage 123. However, the outer surface of the flange 22 is spaced apart from the inner surface of the housing body to form a separation space G such that the hot water or the direct water flows between the outer surface of the flange 22 and the inner surface of the housing body. Accordingly, the intermediate direct water passage 123 is not completely separated by the flange 22. When the hot water passing through the recirculation passage 130 presses the flange 22, the flange 22 is pressed by the hot water in the second reference direction D2 in which the hot water flows, and the entire water-pressure opening/closing body 20 moves in the second reference direction D2. When the direct water presses the flange 22, the flange 22 is pressed by the direct water in the direction opposite to the second reference direction D2, and the entire water-pressure opening/closing body 20 moves in the direction opposite to the second reference direction D2.

The arm 23 also extends from the shaft 21 in the radial direction like the flange 22, but is formed as if a plurality of branches radially extend toward the intermediate direct water passage 123. The arm 23 may make contact with the inner surface of the housing body. Accordingly, the arm 23 supports the shaft 21 against the inner surface of the housing body to help the water-pressure opening/closing body 20 to perform a linear motion well in the intermediate direct water passage 123 without departing from the original position, but is not a component that moves the water-pressure opening/closing body 20 by being pressed by the hot water or the direct water like the flange 22.

The water-pressure opening/closing body 20 includes, in an area adjacent to the recirculation passage 130, a packing 25 formed of a material having elasticity. That is, the packing 25 is disposed at the one end of the shaft 21. The packing 25 may be formed of a material such as rubber having elasticity and may be disposed to cover an opening on one side of the outlet passage 1303 of the outlet case 132 that will be described below. The packing 25 having elasticity may make contact with the outlet case 132 to alleviate impact applied to the outlet case 132 and maintain water tightness of the recirculation passage 130. The packing 25 may be formed in a cylindrical shape as illustrated and may have an inner recess in a shape surrounding the one end of the shaft 21 such that the one end of the shaft 21 is inserted into and coupled to the inner recess, but the shape thereof is not limited thereto.

The water-pressure opening/closing body 20 may further include an elastic member 40 that connects the water-pressure opening/closing body 20 to the inner surface of the housing 10. One end of the elastic member 40 is connected to the water-pressure opening/closing body 20, and an opposite end of the elastic member 40 is connected to the inner surface of the housing 10. In an embodiment of the present disclosure, the elastic member 40 is connected to the back cover 14 constituting the housing 10. The elastic member 40 may be a helical coil spring, but the type thereof is not limited thereto.

The elastic member 40 may have a basic length without being stretched and compressed when the direct water and the hot water are not used and the water temperature of the hot water is higher than or equal to a reference temperature. The location where the water-pressure opening/closing body 20 is located in the intermediate direct water passage 123 when the length of the elastic member 40 is equal to the basic length is referred to as a basic position. That is, when the above-described condition is satisfied, the elastic member 40 has the basic length and locates the water-pressure opening/closing body 20 at the basic position. At the basic position, the packing 25 of the water-pressure opening/closing body 20 may not close the recirculation passage 130. However, according to a modified example of an embodiment, the basic position may be a position where the water-pressure opening/closing body 20 closes the recirculation passage 130.

The elastic member 40 may be stretched by a force by which the direct water presses and moves the water-pressure opening/closing body 20 when the direct water or the hot water is used. The water-pressure opening/closing body 20 is moved by the water pressure of the direct water in the direction toward the recirculation passage 130, that is, in the direction opposite to the second reference direction D2, and the elastic member 40 having the one end coupled to the water-pressure opening/closing body 20 is stretched because the opposite end is connected to the inner surface of the housing 10 but the inner surface of the housing 10 does not move. The elastic member 40 acts an elastic restoring force on the water-pressure opening/closing body 20 in the second reference direction D2. Accordingly, when the use of the direct water is terminated so that an external force acting on the water-pressure opening/closing body 20 other than the restoring force disappears or the remaining external forces are in equilibrium, the water-pressure opening/closing body 20 may be returned to the basic position by the restoring force.

When the direct water and the hot water are not used and the water temperature of the hot water is lower than the reference temperature, the elastic member 40 may be compressed by a force by which the hot water introduced into the intermediate direct water passage 123 along the recirculation passage 130 in the second reference direction D2 presses and moves the water-pressure opening/closing body 20. Since the water-pressure opening/closing body 20 is moved by the water pressure of the hot water in the second reference direction D2 that is a direction away from the recirculation passage 130, the elastic member 40 is compressed between the water-pressure opening/closing body 20 and the inner surface of the housing 10. Accordingly, the elastic member 40 acts the elastic restoring force on the water-pressure opening/closing body 20 in the direction opposite to the second reference direction D2. Thus, when the water temperature of the hot water is higher than or equal to the reference temperature so that the flow rate of the hot water flowing along the recirculation passage 130 is reduced and an external force acting on the water-pressure opening/closing body 20 other than the restoring force disappears or the remaining external forces are in equilibrium, the water-pressure opening/closing body 20 may be returned to the basic position by the restoring force.

The recirculation valve 1 according to an embodiment of the present disclosure may include a filter cover 50. The filter cover 50 may be coupled to a side surface of the recirculation housing 13 that faces in the direction opposite to the second reference direction D2 such that foreign matter in the hot water that is introduced into the recirculation passage 30 is filtered. The filter cover 50 may be formed in a shape covering the side surface of the recirculation housing 13 that faces in the direction opposite to the second reference direction D2 and may be formed double. The filter cover 50 may be a porous mesh.

### Recirculation Housing 13

The recirculation housing 13 may be located between the hot water housing 11 and the direct water housing 12. The recirculation housing 13 includes the inlet case 131. The recirculation housing 13 may include the outlet case 132.

The inlet case 131 is located upstream of the bimetal plate 30 based on the second reference direction D2. An inlet passage 1310 that is a portion of the recirculation passage 130 may be formed in the inlet case 131. Accordingly, the hot water flowing in the hot water passage 110 may flow in the second reference direction D2 through the inlet passage 1310 formed in the inlet case 131 and may be delivered to the bimetal plate 30. The inlet passage 1310 may be located at the center of the bimetal plate 30 when viewed in the second reference direction D2, and therefore the hot water reaching the bimetal plate 30 may spread from the center of the bimetal plate 30 to the outside of the bimetal plate 30.

The housing body and the outer surface of the inlet case 131 may be coupled, and a case O-ring 62 may be disposed therebetween. The case O-ring 62 formed of a material having elasticity maintains water tightness between the inlet case 131 and the inner surface of the housing body to prevent the hot water from being leaked from the boundary therebetween.

An end portion 151 of the front cover may be brought into contact with a side surface of the inlet case 131 that faces in the direction opposite to the second reference direction D2. Accordingly, as the front cover 15 is inserted into the housing body, the end portion 151 of the front cover may be coupled to the housing body while pressing the inlet case 131.

An annular groove may be formed on a side surface of the inlet case 131 that faces the bimetal plate 30, and a contact O-ring 61 may be disposed in the groove. The contact O-ring 61 may be formed of a material having elasticity and may be disposed on the side surface of the inlet case 131 that faces in the second reference direction D2. Accordingly, even though the bimetal plate 30 covers and blocks the inlet passage 1310, the contact O-ring 61 may absorb the impact and may maintain water tightness.

The bimetal plate 30 is disposed adjacent to the side surface of the inlet case 131 that faces the direct water passage 120 among the side surfaces of the inlet case 131. That is, the bimetal plate 30 is located in the second reference direction D2 with respect to the inlet case 131. The inlet case 131 is located closer to the hot water passage 110 than the outlet case 132 that will be described below.

The inlet case 131 includes a case body 1311 and a case locking jaw 1312. A portion of the inlet passage 1310 may be formed to penetrate the case body 1311 in the second reference direction D2. The case body 1311 may be formed in an annular shape surrounding the inlet passage 1310. The case locking jaw 1312 may protrude from the case body 1311 in the direction opposite to the second reference direction D2 and may surround the inlet passage 1310. The case locking jaw 1312 may be formed in a cylindrical shape being hollow and open in the second reference direction D2.

That is, the case body 1311 may have a shape like a cover that covers the space between the hot water passage 110 and the direct water passage 120, and the case locking jaw 1312 may have a shape like a mouth protruding from the cover.

The case locking jaw 1312 may have an area overlapping the hot water passage 110 in the first reference direction D1. The case body 1311 may not overlap the hot water passage 110 in the first reference direction D1.

Based on the second reference direction D2, the length of the case locking jaw 1312 may range from 50% to 100% of the length of the case body 1311. Based on the first reference direction D1, the thickness of the case locking jaw 1312 may be less than or equal to 50% of the thickness of the case body 1311.

The inlet case 131 may further include an inner protrusion 1313 that protrudes from the case body 1311 in the second reference direction D2 and surrounds the inlet passage 1310. The above-described annular groove may be formed on the inner protrusion 1313, and the contact O-ring 61 may be disposed in the groove. That is, the inlet passage 1310 may be defined by the case locking jaw 1312, the case body 1311, and the inner protrusion 1313 in order in the second reference direction D2.

Based on the second reference direction D2, the length of the inlet passage 1310 may be formed to be two or more times greater than the length of the case body 1311. The inlet passage 1310 may include a first inlet passage 1301 and a second inlet passage 1302 in order in the second reference direction D2. The cross-sectional area obtained by cutting the first inlet passage 1301 with a plane perpendicular to the second reference direction D2 may be greater than the cross-sectional area obtained by cutting the second inlet passage 1302 with a plane perpendicular to the second reference direction D2. A tapered passage having a decreasing cross-sectional area in the second reference direction D2 may be formed at the boundary between the first inlet passage 1301 and the second inlet passage 1302. The boundary of the tapered passage may have a slope of 45 degrees when viewed in the cross-section illustrated in FIG. 4. A large amount of hot water may be introduced through the first inlet passage 1301 having a relatively large cross-sectional area to prevent a decrease in circulation flow rate due to pressure loss, and the hot water may be delivered to the second inlet passage 1302 having a smaller cross-sectional area than the first inlet passage 1301 such that a laminar flow of the hot water is delivered to the bimetal plate 30 at an increased flow velocity.

Based on the second reference direction D2, the length of the first inlet passage 1301 may range from 160% to 260% of the length of the second inlet passage 1302. In a cross-section obtained by cutting each passage with a plane perpendicular to the second reference direction D2, the diameter of the first inlet passage 1301 may range from 120% to 130% of the diameter of the second inlet passage 1302.

Since the case locking jaw 1312 is disposed to secure an appropriate length of the inlet passage 1310 in the second reference direction D2, the hot water toward the bimetal plate 30 through the inlet passage 1310 may easily form a laminar flow rather than a turbulent flow, and a pressure deviation in the first reference direction D1 that is formed by the hot water reaching the bimetal plate 30 may be reduced. Accordingly, abnormal operation or vibration that occurs when the bimetal plate 30 operates may be reduced, and thus noise may be reduced.

In addition, since the case locking jaw 1312 having a shape protruding into the hot water passage 110 is disposed, a portion of the hot water flowing in the first reference direction D1 may be blocked by a portion of the case locking jaw 1312 facing in the direction opposite to the first reference direction D1 without being directly introduced into the inlet passage 1310 and has to detour to enter the inlet of the case locking jaw 1312, and thus the inertia of the hot water in the first reference direction D1 may be reduced.

The inlet case 131 may include a case circumference portion 1314. The case circumference portion 1314 may be an annular component formed to surround the case body 1311 when viewed in the second reference direction D2. The case O-ring 62 may be located in a groove formed on the case circumference portion 1314. The case circumference portion 1314 may make contact with the inner surface of the housing body. The inlet case 131 may include an outer protrusion 1315 protruding from the case circumference portion in the second reference direction D2.

The outlet case 132 is a component located in the second reference direction D2 with respect to the bimetal plate 30. The outlet case 132 may include an outlet body 1321. The outlet passage 1303, which is a portion of the recirculation passage 130, may be formed to penetrate the outlet body 1321 in the second reference direction D2. The outlet case 132 may include an outlet protrusion 1322 that surrounds the outlet passage 1303 and protrudes from the outlet case 132 in the second reference direction D2. The water-pressure opening/closing body 20 may be brought into contact with or spaced apart from the outlet protrusion 1322 to open or close the outlet passage 1303.

An outlet circumference portion 1323 extending in the direction opposite to the second reference direction D2 may be formed at the periphery of the outlet body 1321. The outlet circumference portion 1323 may make contact with the inner surface of the housing body. An outlet protrusion 1324 may be further formed from the outlet circumference portion 1323 in the direction opposite to the second reference direction D2. The outlet protrusion 1324 may be formed to be engaged with the outer protrusion 1315 of the inlet case 131 so that the outlet protrusion 1324 and the outer protrusion 1315 may be coupled with each other.

A gap may be formed between the case circumference portion 1314 and the outlet circumference portion 1323, and the periphery of the bimetal plate 30 may be fixedly coupled to the gap. Since the periphery of the bimetal plate 30 is fixed, the central portion other than the periphery of the bimetal plate 30 is deformed when the bimetal plate 30 is deformed.

The outlet case 132 may be stopped by a step protruding inward from the inner surface of the housing body and may be fixed so as not to further deviate in the second reference direction D2.

The water-pressure opening/closing body 20 may be spaced apart from the outlet passage 1303 to open the outlet passage 1303 when the hot water is recirculated and may be brought into contact with the outlet passage 1303 to close the outlet passage 1303 when the direct water or the hot water is used.

The outlet case 132 is disposed closer to the direct water passage 120 than the inlet case 131 and the bimetal plate 30. Accordingly, as illustrated, the inlet case 131 and the outlet case 132 are disposed at positions opposite each other with the bimetal plate 30 therebetween. Thus, a structure in which the bimetal plate 30 is surrounded by the inlet case 131 and the outlet case 132 is formed.

### Bimetal Plate 30

The bimetal plate 30 is further included in the recirculation passage 130. The bimetal plate 30 may be deformed depending on the water temperature of the hot water to open the recirculation passage 130 when the water temperature of the hot water is lower than the reference temperature and to close the recirculation passage 130 when the water temperature of the hot water is higher than or equal to the reference temperature.

The bimetal plate 30 is constituted by bimetal, the shape of which changes depending on temperature. The bimetal is a member formed in a state in which two metals having different coefficients of thermal expansion are in contact with each other and opposite ends are coupled, and the two metals extend or contract by different percentages depending on temperature to change the direction and degree of bending of the bimetal. Accordingly, the shape of the bimetal plate 30 may be changed depending on the water temperature of the hot water flowing in the housing 10 of the recirculation valve 1.

A plurality of holes 300 formed to penetrate the bimetal plate 30 may be spaced apart from one another by a predetermined gap in an area adjacent to the periphery of the bimetal plate 30. Accordingly, the hot water flowing through the inlet passage 1310 may penetrate the bimetal plate 30 through the holes 300 and may flow from the hot water passage 110 to the outlet passage 1303. The hot water delivered to the outlet passage 1303 is discharged into the intermediate direct water passage 123.

Specifically, the diameter of each hole 300 may preferably be 2.2 mm, and the number of holes 300 may be eight. In addition, the diameter of the bimetal plate 30 may preferably range from 23.7 mm to 23.8 mm, the thickness thereof may be 0.4 mm, and the maximum thickness when the bimetal plate 30 is deformed may be 0.8 mm.

When the water temperature of the hot water is lower than the reference temperature, the bimetal plate 30 is spaced apart from the inlet passage 1310, and when the water temperature of the hot water is higher than or equal to the reference temperature, the bimetal plate 30 makes contact with the inlet passage 1310, which is a partial section of the recirculation passage 130, to close the inlet passage 1310. Specifically, when the water temperature of the hot water is lower than the reference temperature, the bimetal plate 30 is deformed to deviate from the contact O-ring 61 surrounding the inlet passage 1310, and when the water temperature of the hot water is higher than or equal to the reference temperature, the bimetal plate 30 is deformed to make contact with the contact O-ring 61. Accordingly, the bimetal plate 30 opens the recirculation passage 130 when the water temperature of the hot water is lower than the reference temperature and closes the recirculation passage 130 when the water temperature of the hot water is higher than or equal to the reference temperature.

More specifically describing the shape in which the bimetal plate 30 is deformed, the bimetal plate 30 may be curved in a shape convex from the hot water passage 110 toward the direct water passage 120, that is, in a shape convex in the second reference direction D2 when the water temperature of the hot water is lower than the reference temperature. In contrast, when the water temperature of the hot water is higher than or equal to the reference temperature, the bimetal plate 30 may be curved in a shape convex from the direct water passage 120 toward the hot water passage 110, that is, in a shape convex in the direction opposite to the second reference direction D2. Since the bimetal plate 30 is deformed to have the shapes described above, the bimetal plate 30 may form, between the bimetal plate 30 and the inlet passage 1310, a passage through which the hot water flows or may close the inlet passage 1310. When the water temperature of the hot water is higher than or equal to the reference temperature, the central portion of the bimetal plate 30 moves toward the contact O-ring 61 and makes contact with the contact O-ring 61 to close the inlet passage 1310.

However, in a modified example, when the water temperature of the hot water is lower than the reference temperature, the bimetal plate 30 may be convex in the second reference direction D2, and when the water temperature of the hot water is higher than or equal to the reference temperature, the bimetal plate 30 may be deformed into the shape of a flat plate perpendicular to the second reference direction D2 to close the inlet passage 1310.

### ANOTHER EMBODIMENT

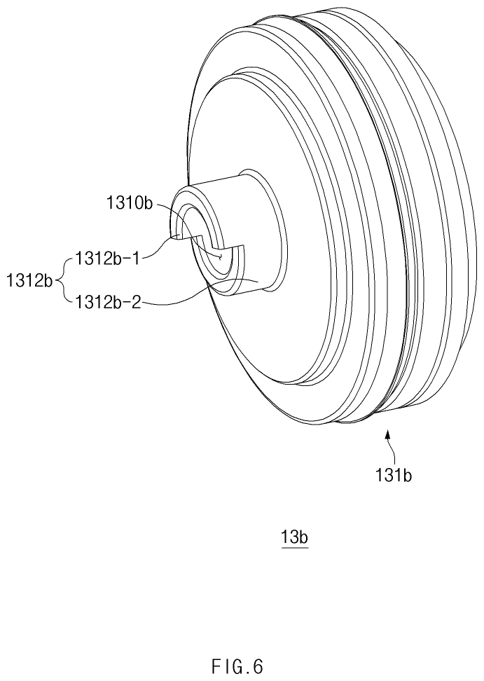

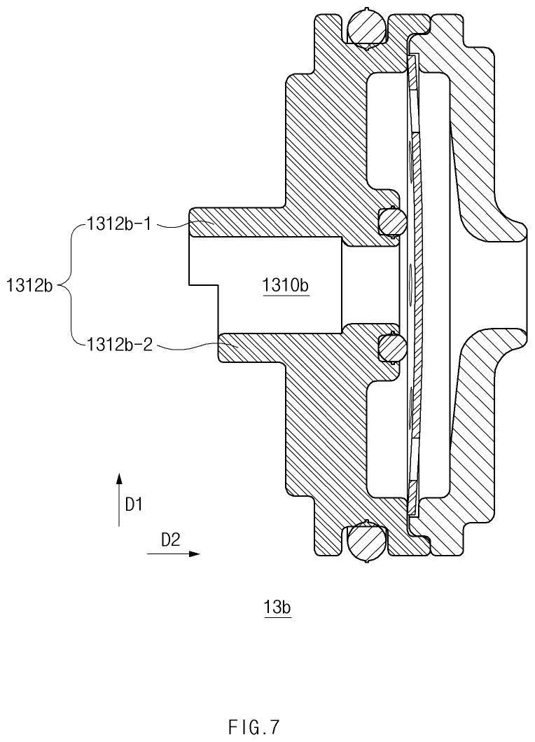

FIG. 6 is a perspective view of a recirculation housing 13b according to the other embodiment of the present disclosure. FIG. 7 is a longitudinal sectional view of the recirculation housing 13b of a recirculation valve according to the other embodiment of the present disclosure.

Since the recirculation valve according to the other embodiment of the present disclosure only differs from the recirculation valve 1 according to the embodiment of the present disclosure in terms of the configuration of the recirculation housing 13b, the recirculation housing 13b having the difference will be described in more detail, and the description provided for the recirculation valve 1 according to the embodiment of the present disclosure may be applied to the remaining components as it is.

A case locking jaw 1312b of an inlet case 131b of the recirculation housing 13b includes a first locking jaw portion 1312b-1 that covers one side of an inlet passage 1310b that faces in the first reference direction D1 and a second locking jaw portion 1312b-2 located in the direction opposite to the first reference direction D1 with respect to the first locking jaw portion 1312b-1. The first locking jaw portion 1312b-1 has a shape that protrudes further in the second reference direction D2 than the second locking jaw portion 1312b-2. Due to this shape, hot water flowing in the first reference direction D1 in a hot water passage may be blocked by the first locking jaw portion 1312b-1 and may be guided into the inlet passage 1310b in the second reference direction D2.

Each of the first locking jaw portion 1312b-1 and the second locking jaw portion 1312b-2 may have a semicircular shape when viewed in the second reference direction D2.

Hereinabove, even though all of the components are coupled into one body or operate in a combined state in the description of the above-mentioned embodiments of the present disclosure, the present disclosure is not limited to these embodiments. That is, all of the components may operate in one or more selective combination within the range of the purpose of the present disclosure. It should be also understood that the terms of “include”, “comprise” or “have” in the specification are “open type” expressions just to say that the corresponding components exist and, unless specifically described to the contrary, do not exclude but may include additional components. Unless otherwise defined, all terms used herein, including technical and scientific terms, have the same meaning as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. A recirculation valve comprising:
a hot water housing fluidically connected to a hot water supply pipe configured to supply hot water generated by heating raw water, the hot water housing being configured to form a hot water passage through which the hot water flows in a first reference direction;
a direct water housing fluidically connected to a direct water supply pipe configured to supply direct water being raw water, the direct water housing being configured to form a direct water passage through which the direct water flows;
a recirculation housing configured to form a recirculation passage in a second reference direction perpendicular to the first reference direction to fluidically connect the hot water passage and the direct water passage and cause the hot water in the hot water passage to flow into the direct water passage;
a water-pressure opening/closing body provided in the direct water housing to close or open the recirculation passage; and
a bimetal plate disposed in the recirculation housing and deformed depending on a water temperature of the hot water to open or close an inlet passage being a portion of the recirculation passage,
wherein the recirculation housing includes an inlet case located upstream of the bimetal plate based on the second reference direction, and
wherein the inlet case includes a case body having the inlet passage formed therein and a case locking jaw configured to protrude from the case body in a direction opposite to the second reference direction and surround the inlet passage.

2. The recirculation valve of claim 1, wherein the case locking jaw has an area configured to overlap the hot water passage in the first reference direction.

3. The recirculation valve of claim 2, wherein the case body does not overlap the hot water passage in the first reference direction.

4. The recirculation valve of claim 1, wherein the case locking jaw is formed in a cylindrical shape being hollow and open in the second reference direction.

5. The recirculation valve of claim 1, wherein the inlet case further includes an inner protrusion configured to protrude from the case body in the second reference direction and surround the inlet passage, and
wherein based on the second reference direction, a length of the inlet passage is formed to be two or more times greater than a length of the case body.

6. The recirculation valve of claim 1, wherein the inlet passage includes a first inlet passage and a second inlet passage in order in the second reference direction, and
wherein a cross-sectional area obtained by cutting the first inlet passage with a plane perpendicular to the second reference direction is greater than a cross-sectional area of the second inlet passage.

7. The recirculation valve of claim 6, wherein based on the second reference direction, a length of the first inlet passage ranges from 160% to 260% of a length of the second inlet passage.

8. The recirculation valve of claim 1, wherein the case locking jaw includes a first locking jaw portion configured to cover one side of the inlet passage configured to face in the first reference direction and a second locking jaw portion located in a direction opposite to the first reference direction with respect to the first locking jaw portion, and
wherein the first locking jaw portion has a shape protruding further in the second reference direction than the second locking jaw portion.

9. The recirculation valve of claim 8, wherein each of the first locking jaw portion and the second locking jaw portion has a semicircular shape when viewed in the second reference direction.
